(19) United States
(12) Patent Application Publication
(10) Pub. No.: US 2026/0079877 A1
(43) Pub. Date: Mar. 19, 2026

(54) READOUT DEVICE, SYSTEM, AND METHOD

(71) Applicant: Festo SE & Co. KG, Esslingen (DE)

(72) Inventors: Jan REIMER, Esslingen (DE); Dominik LENZ, Denkendorf (DE); Christian GRÖLING, Böblingen (DE); Frederik HERTLER, Filderstadt (DE)

(21) Appl. No.: 19/326,357

(22) Filed: Sep. 11, 2025

(30) Foreign Application Priority Data
Sep. 13, 2024 (DE) 10 2024 126 492.6

(51) Int. Cl. G06F 13/42

(52) U.S. Cl. CPC G06F 13/4282

(57) ABSTRACT

A readout device for industrial automation, for reading out a signal transmitter. The readout device includes: a computing unit including a first serial interface and a second serial interface, in which the first serial interface has a first data output, a first data input and preferably a clock output, and the second serial interface has a second data output, a second data input and a clock input. The clock input is connected to the first data output and the computing unit is designed to output a clock signal at the first data output for clocking both the signal transmitter to be read out and the second serial interface, and to receive a signal transmitter data signal originating from the signal transmitter by means of the first data input and/or the second data input.

### CROSS-REFERENCE TO RELATED APPLICATION

This application claims priority to German application no. 10 2024 126 492.6 filed Sep. 13, 2024, which is incorporation by reference.

### BACKGROUND OF THE INVENTION

The invention relates to a readout device for industrial automation, for reading out a signal transmitter, wherein the readout device comprises: a computing unit comprising a first serial interface and a second serial interface, wherein the first serial interface has a first data output, a first data input, and preferably a clock output, and the second serial interface has a second data output, a second data input, and a clock input.

The signal transmitter comprises, for example, a position encoder and is configured in particular to provide position information via a signal transmitter data signal. The readout device serves in particular to receive the signal transmitter data signal and to read out the position information from it. The signal transmitter may be referred to as signal emitter or signal source.

### SUMMARY OF THE INVENTION

One object of the invention is to enable flexible reading out of the signal transmitter in an efficient manner.

The object is solved by a readout device according to claim 1. The clock input of the second serial interface of the readout device is connected to the first data output, and the computing unit is configured to output a clock signal at the first data output for clocking both the signal transmitter to be read out and the second serial interface, and to receive, by means of the first data input and/or the second data input, the signal transmitter data signal originating from the signal transmitter. The clock input is connected to the first data output in particular via a line (in particular running externally to the computing unit), for example a conductor track and/or a cable.

In the approach described above, the first data output is used (in particular instead of the clock output) to generate the clock signal. Conventionally, the data output is used to output a data signal and not a clock signal. Using the data output to output the clock signal opens up new possibilities for generating the clock signal-in particular, the clock signal can be generated at a frequency that is many times smaller than an internal clock signal of the first serial interface (or an interface clock signal that can be tapped at the clock output). Since the clock signal is used both to clock the signal transmitter to be read out and the second serial interface, it is possible to operate the second serial interface with the same clock at which the signal transmitter outputs its signal transmitter data signal. This allows the signal transmitter data signal to be easily received via the second serial interface. Furthermore, the signal transmitter data signal can also be received (in particular additionally or alternatively) via the first serial interface. If the first serial interface is operated at a higher clock frequency than the second serial interface, oversampling of the signal transmitter data signal can take place in this case in order, for example, to record a time value, in particular a recovery time, which is explained in more detail below, with a sufficiently high degree of accuracy.

The signal transmitter is designed in particular to communicate in accordance with the ENDAT 2.1 or ENDAT 2.2 protocol. Conventionally, such a signal transmitter is read out using an FPGA or a microcontroller with special peripherals. The approach described above makes it possible in particular to read out such a signal transmitter using a standard microcontroller. In particular, no additional timer unit and/or interrupt is required during data communication, i.e., during readout. Consequently, the approach described above can be implemented, for example, in the firmware of the microcontroller.

Advantageous further developments are the subject of the dependent claims.

The computing unit is preferably a microcontroller. In particular, the computing unit is designed as a standard microcontroller. By using a microcontroller as the computing unit, the readout device can be implemented in an efficient manner.

Preferably, the first serial interface is a first SPI interface and/or the second serial interface is a second SPI interface. Microcontrollers usually have at least two (free) SPI interfaces. The first serial interface is operated, for example, as an SPI master and the second serial interface as an SPI slave. By interconnecting the first data output—in particular the SPI MOSI connection—of the first SPI interface with the clock input—in particular the SPI CLK IN connection—of the second SPI interface, the approach described above for reading out the signal transmitter can be efficiently implemented with two SPI interfaces.

Preferably, the computing unit is configured to output a readout device data signal to the signal transmitter via the second data output. The readout device data signal serves in particular to transmit a request for current position information and/or a configuration command and/or a control command. Since the second serial interface is operated with the same clock signal as the signal transmitter, the output of the readout device data signal can be easily implemented in such a way that the readout device data signal can be received by the signal transmitter. For example, one data bit can be transmitted per clock cycle of the clock signal.

Preferably, the readout device is configured to operate the first serial interface at a higher clock frequency than the second serial interface in order to read out the signal transmitter. In this way, the second serial interface can be operated at the same clock frequency as the signal transmitter—whereby communication with the signal transmitter can be implemented in an efficient manner—while the first serial interface is operated at a higher clock frequency and can thus, for example, perform a detailed data analysis of the received signal transmitter data signal.

Preferably, the computing unit is configured to receive the signal transmitter data signal via the first data input in order to record, and in particular to measure, on the basis of the signal transmitter data signal, a time value related to the operation of the signal transmitter. The time value is, in particular, a time difference between the end of a clock provided by the clock signal and a level change of the signal transmitter data signal caused by the end of the clock. For example, the time value is a so-called recovery time. Preferably, the readout device is configured to provide diagnosis information regarding the signal transmitter based on the time value. For example, the readout device checks, based on the time value, whether requirements for a safety-related operation are met and provides corresponding diagnosis information indicating the result of this check.

The invention further relates to a system comprising the readout device and the signal transmitter. Preferably, the signal transmitter comprises a position encoder which is configured to provide the signal transmitter data signal.

Preferably, the system further comprises a signal converter device connected between the readout device and the signal transmitter so that the clock signal, the signal transmitter data signal, and/or the readout device data signal passes through the signal converter device. The signal converter device is preferably configured to perform, for the clock signal, the signal transmitter data signal, and/or the readout device data signal, level conversion and/or signal transmission type conversion between a single-ended signal transmission mode and a differential signal transmission mode. Preferably, the signal converter device comprises at least one RS485 interface by means of which the level conversion and/or the signal transmission type conversion is performed.

Preferably, the signal converter device has at least a switching input, a signal converter input, a signal converter output, and a bidirectional signal converter port, wherein the bidirectional signal converter port is connected to a bidirectional signal transmitter data port of the signal transmitter and can be switched via the switching input between an input mode for receiving the signal transmitter data signal from the signal transmitter data port and an output mode for outputting the readout device data signal to the signal transmitter data port. In the input mode, a logic level present at the bidirectional signal converter port is provided at the signal converter output. In the output mode, a logic level present at the signal converter input is provided at the bidirectional signal converter port.

The signal converter input is expediently set to a fixed voltage level, the switching input is connected to the second data output of the readout device, and the signal converter output is connected to the second data input of the readout device. The fixed voltage level is, in particular, a logic high level. Preferably, the readout device data signal to be transmitted to the signal transmitter is fed into the switching input and, in particular, not into the signal converter input, which is (conventionally) intended for this purpose. In this way, the readout device data signal itself can be used to switch between the input mode and the output mode, so that it is not necessary to provide an additional switch signal for this purpose.

In particular, the signal converter port is connected to the signal transmitter data port via a first data line for non-inverted signal transmission and a second data line for inverted signal transmission. The system expediently includes a pull-up resistor connected to the second data line and a pull-down resistor connected to the first data line. In response to the readout device data signal having a logic high level, the signal converter device switches to output mode so that a logic high level is provided at the bidirectional signal converter port in accordance with the fixed voltage level applied to the signal converter input. In response to the readout device data signal having a logic low level, the signal converter device switches to input mode and, due to the pull-up resistor and the pull-down resistor, the bidirectional signal converter port is pulled to a logic low level. A logic low level at the switching input can be used, on the one hand, to send a logic low level to the signal transmitter and, on the other hand, to receive the signal transmitter data signal. Consequently, bidirectional communication can be enabled in an efficient manner. In particular, bidirectional communication with bit-accurate switching between transmitted and received data bits is enabled.

According to an alternative design, the computing unit has a third serial interface with a third data output to which the switching input is connected, the signal converter input is connected to the second data output, and the signal converter output is connected to the second data input and/or the first data input. Preferably, a third SPI interface is used as the third serial interface. By means of the third serial interface, the bidirectional signal converter port can be switched between the input mode and the output mode. This eliminates the need for passive transmission of the low state.

The invention also relates to a method for operating the readout device or system, comprising the steps of: outputting the clock signal for clocking both the signal transmitter to be read out and the second serial interface, and receiving, by means of the first data input and/or the second data input, the signal transmitter data signal originating from the signal transmitter.

### BRIEF DESCRIPTION OF THE DRAWINGS

Further exemplary details and exemplary embodiments are explained below with reference to the figures.

FIG. 1 shows a schematic representation of a system according to a first embodiment, with a readout device, a signal transmitter, and a signal converter device.

FIG. 2 shows a diagram with temporal courses of a clock signal, a signal transmitter data signal, and an internal clock signal,

FIG. 3 a schematic representation of a system according to a second embodiment, with a readout device according to a second embodiment, a signal transmitter, and a signal converter device.

### DETAILED DESCRIPTION

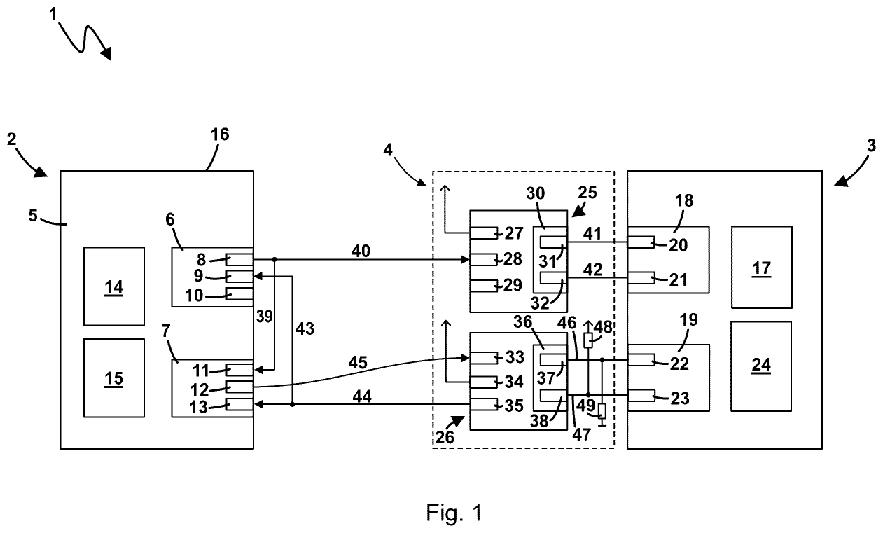

FIG. 1 shows a schematic representation of a system 1 according to a first embodiment, comprising a readout device 2, a signal transmitter 3, and optionally a signal converter device 4. The system 1 represents an exemplary application environment for the readout device 2. The readout device 2 may also be provided on its own.

The readout device 2 is used to read out the signal transmitter 3. Expediently, the readout device 2 and/or the signal transmitter 3 are designed for industrial automation.

The readout device 2 comprises a computing unit 5, which is designed, for example, as a microcontroller. In particular, the computing unit 5 is not designed as an FPGA. The computing unit 5 represents the readout device 2 by way of example. The computing unit 5 expediently comprises a computing unit housing 16, which in particular represents the outer housing of the computing unit 5.

The computing unit 5 comprises a first serial interface 6 and a second serial interface 7. The first serial interface 6 is designed in particular as a first SPI interface. The second serial interface 7 is designed in particular as a second SPI interface. SPI stands for “Serial Peripheral Interface”. The “SPI interface” may also be referred to as “SPI”.

The first serial interface 6 has a first data output 8 and a first data input 9. Preferably, the first serial interface further has a clock output 10. The first data output 8 is, in particular, an SPI-MOSI connection. SPI-MOSI stands for “Serial Peripheral Interface Master Output Slave Input”. The first data input 9 is, in particular, an SPI-MISO connection. SPI-MISO stands for “Serial Peripheral Interface Master Input Slave Output”.

The second serial interface 7 has a second data output 12, a second data input 13, and a clock input 11. The second data output 12 is, in particular, an SPI-MISO connection. The second data input 13 is, in particular, an SPI-MOSI connection.

The computing unit 5 preferably comprises a processor unit 14 having at least a processor core and a memory unit 15. The processor unit 14 is configured in particular to process data received via the serial interfaces 6, 7 and/or to provide data to be sent via the serial interfaces 6, 7, in particular to generate such data. The memory unit 15 preferably comprises a volatile memory, for example a working memory, and/or a non-volatile memory. According to an alternative design, the memory unit 15 or part of the memory unit 15, for example the non-volatile memory, may be arranged externally to the computing unit 5.

The signal transmitter 3 is designed to output a signal transmitter data signal. Preferably, the signal transmitter 3 is a sensor device, in particular a sensor device for detecting a position, for example a linear or rotary position. Preferably, the signal transmitter 3 comprises a sensor unit 17, in particular a position encoder, which is designed to provide the signal transmitter data signal. The signal transmitter data signal contains, for example, position information that represents a position detected by the signal transmitter 3. For example, the signal transmitter 3 serves to detect a position of a drive, in particular a servo drive. For example, the signal transmitter 3 detects the position of a drive member, in particular a rotor or carriage, of the drive. The signal transmitter 3 preferably has a safety approval of SIL 3 or below.

The signal transmitter 3 preferably comprises a signal transmitter clock input 18 and a (in particular bidirectional) signal transmitter data port 19, which are preferably not designed as SPI interfaces. The signal transmitter clock input 18 includes, for example, a non-inverted clock line connection 20 and an inverted clock line connection 21. The signal transmitter data port 19 includes, for example, a non-inverted data line connection 22 and an inverted data line connection 23.

The signal transmitter 3 is expediently designed to communicate according to a synchronous serial protocol, in particular via the signal transmitter data port 19. For example, the signal transmitter 3 is designed to communicate according to the ENDAT 2.1 or ENDAT 2.2 protocol (in particular including a diagnostic function for safety position transmitters), in particular via the signal transmitter data port 19. Furthermore, the signal transmitter 3 can be designed to communicate according to an SPI protocol or a BISS-C protocol, in particular via the signal transmitter data port 19.

The signal transmitter clock input 18 is expediently configured to receive a clock signal provided by the readout device 2. The signal transmitter 3 is expediently designed to output the signal transmitter data signal at the signal transmitter data port 19, in particular in accordance with the clock signal received at the signal transmitter clock input 18, and/or to receive a readout device data signal, in particular in accordance with the clock signal; preferably, the received clock signal specifies the timing of the output of the signal transmitter data signal and/or the reception of the readout device data signal. The signal transmitter 3 is designed, for example, to receive the clock signal and/or the readout device data signal as a differential signal and/or to output the signal transmitter data signal as a differential signal. The term “differential signal” refers to a signal transmitted by means of differential signal transmission. Differential signal transmission can also be referred to as symmetrical signal transmission.

The signal transmitter 3 further comprises a signal transmitter computing unit 24, which is preferably designed to receive the clock signal via the signal transmitter clock input 18 and/or to generate the signal transmitter data signal to be output via the signal transmitter data port 19 and/or to receive the readout device data signal via the signal transmitter data port 19.

For example, the system 1 comprises the signal converter device 4, which is connected in particular between the readout device 2 and the signal transmitter 3, so that the clock signal, the signal transmitter data signal and/or the readout device data signal passes through the signal converter device 4. The signal converter device 4 is preferably configured to perform, for the clock signal, the signal transmitter data signal, and/or the readout device data signal, a level conversion and/or to perform a signal transmission type conversion between single-ended signal transmission and differential signal transmission.

Preferably, the signal converter device 4 comprises at least one RS485 interface by means of which the level conversion and/or the signal transmission type conversion is performed.

Preferably, the signal converter device 4 comprises a first signal converter unit 25 and a second signal converter unit 26. The first signal converter unit 25 is connected between the first serial interface 6 and the signal transmitter clock input 18. The second signal converter unit 26 is connected between the second serial interface 7 and the signal transmitter data port 19. The signal converter units 25, 26 are expediently designed as RS485 interfaces.

The first signal converter unit 25 comprises a first switching input 27, a first signal converter input 28, (optionally) a first signal converter output 29, and a (particularly bidirectional) first signal converter port 30. The first signal converter port 30 expediently comprises a first non-inverted line connection 31 and a first inverted line connection 32.

The second signal converter unit 26 comprises a second switching input 33, a second signal converter input 34, a second signal converter output 35, and a (in particular bidirectional) second signal converter port 36. The second signal converter port 36 expediently comprises a second non-inverted line connection 37 and a second inverted line connection 38.

Each signal converter unit 25, 26 can be switched between a respective input mode and a respective output mode, in particular via the respective switching input 27, 33. In output mode, a signal applied to the respective signal converter input 28 is converted into a signal that can be tapped at the respective signal converter port 30, 36. In input mode, a signal applied to the respective signal converter port 30, 36 is converted into a signal that can be tapped at the respective signal converter output 29, 35.

In response to a logic high level being present at the respective switching input 27, 33, the respective signal converter unit enters output mode. In response to a logic low level being present at the respective switching input 27, 33, the respective signal converter unit assumes the input mode.

Each signal converter unit 25, 26 is configured to perform a respective level conversion and a respective signal transmission type conversion between single-ended signal transmission and differential signal transmission. The term “signal transmission type conversion” refers to a conversion of the type of signal transmission between single-ended signal transmission and differential signal transmission. The term “single-ended signal transmission” refers to non-differential signal transmission. In level conversion, the respective voltage level of the high level and/or low level is converted between two values.

The interconnection of the components of system 1 is described below.

The clock input 11 is connected to the first data output 8, for example via a first clock line 39. The signal transmitter clock input 18 is connected to the first data output 8, for example via the signal converter device 4. In particular, the first signal converter input 28 is connected to the first data output 8, for example via a second clock line 40. The first clock line 39 is branched off from the second clock line 40, for example. The signal transmitter clock input 18 is connected to the first signal converter port 30. For example, the non-inverted clock line connection 20 is connected to the first non-inverted line connection 31 via a first line 41, and the inverted clock line connection 21 is connected to the inverted line connection 32 via a second line 42. The first switching input 27 is set to a fixed voltage level, in particular to a logic high level. The first signal converter output 29 is expediently left unassigned.

The signal transmitter data port 19 is connected to the first data input 9, the second data input 13, and preferably the second data output 12, in particular via the signal converter device 4. The first data input 9 is connected to the second signal converter output 35, in particular via a first signal transmitter data signal line 43. The second data input 13 is connected to the second signal converter output 35, in particular via a second signal transmitter data signal line 44. For example, the first signal transmitter data signal line 43 is branched off from the second signal transmitter data signal line 44. The second switching input 33 is connected to the second data output 12, for example via a readout device data signal line 45. The second signal converter input 34 is set to a fixed voltage level, in particular to a logic high level.

The second signal converter port 36 is connected to the signal transmitter data port 19, in particular via a first data line 46 and a second data line 47. The first data line 46 is used for non-inverted signal transmission and the second data line 47 is used for inverted signal transmission.

The system 1 further comprises a pull-up resistor 48 connected to the second data line 47 and a pull-down resistor 49 connected to the first data line 46.

The lines 39, 40, 41, 42, 43, 44, 45, 46, 47 listed are implemented externally to the computing unit 5, the signal transmitter 3, and/or the signal converter device 4, for example via conductor tracks and/or cables.

According to an alternative design, the signal converter device 4 is not present; in particular, in this case, the computing unit 5 is connected directly to the signal transmitter 3. In this case, for example, the computing unit 5 and the signal transmitter 3 communicate in the same way (e.g., non-differential) and/or with the same logic levels.

The operation of the system 1 will be discussed in more detail below.

The computing unit 5 outputs the clock signal at the first data output 8 for clocking both the signal transmitter 3 to be read out and the second serial interface 7. For example, the clock signal is transmitted via the first signal converter unit 25 to the signal transmitter 3, in particular to the signal transmitter clock input 18. Furthermore, the clock signal 50 is output (in particular directly) from the first data output 8 to the clock input 11. The clock signal 50 alternates between a logic high level and a logic low level, which are expediently provided by the computing unit 5 with the same (and in particular constant) time duration in each case.

The computing unit 5 is expediently designed to provide an internal clock 52 that is different from the clock of the clock signal. Expediently, the computing unit 5 operates the first serial interface 6 according to the internal clock. For example, the internal clock determines the maximum temporal resolution with which the computing unit 5 can output the clock signal 50 via the first data output 8 and/or receive the signal transmitter data signal via the first data input 9 and/or the times at which the computing unit 5 reads in a new signal value of the signal transmitter data signal at the first data input 9 and/or outputs a new signal value of the clock signal at the first data output 8. In particular, the internal clock has a higher frequency than the clock signal. For example, the frequency of the internal clock is an integer multiple of the frequency of the clock signal (in particular, at least twice or three times as high). The internal clock can be tapped at the clock output 10, for example. The signal providing the internal clock shall also be referred to as the interface clock signal.

Expediently, the computing unit 5 operates the second serial interface 7 in accordance with the clock signal received via the clock input 11. For example, the clock of the clock signal determines the maximum temporal resolution with which the computing unit 5 can output the readout device data signal via the second data output 12 and/or the signal transmitter data signal can be received via the second data input 13 and/or the times at which the computing unit 5 reads in a new signal value of the signal transmitter data signal at the second data input 13 and/or outputs a new signal value of the readout device data signal at the second data output 12. For example, the computing unit 5 reads exactly one data bit of the signal transmitter data signal per clock cycle of the clock signal via the second data input 13. For example, the computing unit 5 outputs exactly one data bit of the readout device data signal per clock cycle of the clock signal via the second data output 12.

Expediently, the signal transmitter 3 operates the communication via the signal transmitter data port 19 in accordance with the clock of the clock signal 50 transmitted in particular via the signal converter device 4 and received at the signal transmitter clock input 18. For example, the clock of the clock signal determines the maximum temporal resolution with which the signal transmitter 3 can read in the readout device data signal via the signal transmitter data port 19 and/or output the signal transmitter data signal via the signal transmitter data port 19 and/or the times at which the signal transmitter 3 outputs a new signal value of the signal transmitter data signal at the signal transmitter data port 19 and/or reads in a new signal value of the readout device data signal at the signal transmitter data port 19. For example, the signal transmitter 3 reads exactly one data bit of the readout device data signal per clock cycle of the clock signal via the signal transmitter data port 19. For example, the signal transmitter 3 outputs exactly one data bit of the signal transmitter data signal per clock cycle of the clock signal via the signal transmitter data port 19.

The computing unit 5 is configured to receive the signal transmitter data signal originating from the signal transmitter 3 via the first data input 9 and/or the second data input 13. The data transmitted via the signal transmitter data signal is transmitted in particular as telegrams.

Preferably, the readout device 2 operates the first serial interface 6 at a higher clock frequency than the second serial interface 7 in order to read out the signal transmitter 3. As already mentioned above, the first serial interface 6 is operated according to the interface clock signal and the second serial interface with the clock signal 50 output at the first data output 8.

The computing unit 5 is expediently configured to output the readout device data signal to the signal transmitter 3 via the second data output 12. The data transmitted by means of the readout device data signal is transmitted in particular as telegrams. Via the readout device data signal, the computing unit 5 sends, for example, a request to the signal transmitter 3, for example a request for current position information, and/or a configuration command and/or a control command.

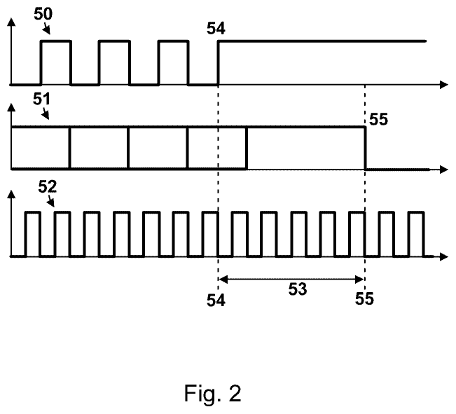

FIG. 2 shows a diagram with temporal courses of the clock signal 50, the signal transmitter data signal 51, and the internal clock signal 52. Time is plotted on the horizontal axis and the logic levels are plotted on the vertical axes. With reference to FIG. 2, the acquisition of a time value will be explained below.

Preferably, the computing unit 5 is configured to receive the signal transmitter data signal 51 at the first data input 9 in order to detect, on the basis of the signal transmitter data signal 51, a time value related to the operation of the signal transmitter 3. For example, the time value is a time difference 53 between an end 54 of a clock provided by the clock signal 50 and a level change 55 of the signal transmitter data signal 51 caused by the end 54. The provided clock is terminated in particular by the computing unit 5 setting the clock signal 50 permanently (or at least over a plurality of clock periods) to a constant logic level—in this example, to the logic high level; alternatively, it could also be set to the low level in order to terminate the clock. In the level change 55, the signal transmitter data signal 51 changes its logic level—for example, from a logic high level to a logic low level—and then remains at the changed logic level (for example, the low level), in particular permanently or temporarily, for example until the clock signal 50 is resumed or until a predetermined time period has elapsed.

The signal transmitter 3 expediently has its own internal clock signal and is in particular able to continue its operation even without the clock signal 50, in particular to provide certain functions. For example, the signal transmitter 3 is configured to change the logic level of the signal transmitter data signal 51 in response to the clock signal 50 ending, in particular after a predetermined time period measured (in particular by the signal transmitter 3) has elapsed (for example, a predetermined number of cycles of the internal clock of the signal transmitter 3).

The readout device 2 is preferably configured to provide diagnosis information regarding the signal transmitter 3 based on the time value. The time value is, in particular, a recovery time and is, for example, an indicator of the correct functioning of the signal transmitter 3. For example, the computing unit 5 performs (in particular, repeated) detection and checking of the time value, in particular within the framework of safety-oriented operation of the signal transmitter 3. For example, the computing unit 5 repeatedly, in particular periodically, terminates the clock signal 50 in order to repeatedly, in particular periodically, detect and check the time value (in particular to the level change 55 of the signal transmitter data signal 51 by the signal transmitter 3). For example, the computing unit 5 checks the time value by comparing it with a predetermined threshold value. Expediently, the computing unit 5 generates the diagnosis information based on the comparison. The diagnosis information indicates, in particular, whether the time value is within a permissible range or whether there is an impermissible deviation of the time value. Expediently, the diagnosis information can indicate whether or not the signal transmitter 3 is operating safely.

Expediently, the computing unit 5 resumes the clock signal after the end 54 of this clock, in particular after a predetermined period of time has elapsed after the end 54.

Preferably, the time value is measured following a request from the computing unit 5—i.e., in particular, after the computing unit 5 has transmitted. Telegrams that end in a response from the signal transmitter 3 (i.e., the signal transmitter 3 transmits) are expediently transferred with a continuous clock to a telegram containing a request from the computing unit 5, so that the time value can be expediently measured in each cycle.

Expediently, the time value can be determined by the computing unit 5 by reading and analyzing the signal transmitter data signal 51 and counting the signal cycles of the internal clock 52 from the end 54 of the clock provided by the clock signal 50 to the level change 55 of the signal transmitter data signal 51.

The following section describes how data can be transferred bidirectionally between the readout device 2 and the signal transmitter 3 via the second signal converter unit 26.

First, the transmission of the readout device data signal from the readout device 2 to the signal transmitter 3 will be discussed.

The readout device 2 outputs the readout device data signal to the second switching input 33. A logic high level of the readout device data signal present at the second switching input 33 causes the second signal converter unit 26 to assume the output mode; i.e., the second signal converter unit 26 outputs the logic level present at the second signal converter input 34—i.e., a logic high level-at the second signal converter port 36. A logic low level of the readout device data signal applied to the switching input 33 causes the second signal converter unit 26 to assume the input mode; i.e., the second signal converter unit 26 outputs the logic level applied to the second signal converter port 36 at the second signal converter output. Expediently, in the input mode, the second signal converter port 36 is high-impedance. Preferably, the signal transmitter 3 does not transmit during the transmission of the readout device data signal, but is switched to receive mode with its signal transmitter data port 19, so that expediently the signal transmitter data port 19 is also high-impedance. The logic level at the signal transmitter data port 19 is therefore determined in this state by the pull-up resistor 48 and the pull-down resistor 49, so that a logic low level is established at the signal transmitter data port 19. Consequently, both logic high levels and logic low levels can be transmitted from the readout device 2 to the signal transmitter 3.

Next, we will discuss the transmission of the signal transmitter data signal from signal transmitter 3 to the readout device 2.

For this transmission, the readout device 2 outputs a logic low level at the second data output 12 in order to set the second signal converter unit 26 to the input mode, in which the second signal converter unit 26 outputs the logic level present at the second signal converter port 36 at the second signal converter output 35. In this state, the logic level provided at the signal transmitter data port 19 (of the signal transmitter data signal to be transmitted) determines the logic level output at the signal converter output 35 (and received by the first data input 9 and/or second data input 13).

Preferably, the first serial interface 6 generates bit-accurate clock signals-in particular the clock signal 50—and evaluates incoming data—in particular the signal transmitter data signal—by means of oversampling. The internal clock of the first serial interface 6 is preferably an integer multiple higher than the clock that can be tapped at the clock output 10.

The second serial interface 7 synchronizes (via the clock signal 50) to the first serial interface 6 and generates the outgoing data—the readout device data signal.

The transmitted data—the readout device data signal—is sent via an output enable the second switching input 33—of an RS485 transceiver—the signal converter device 4—so that no dedicated switching from transmit to receive via separate control signals is necessary. The data line—in particular lines 46, 47—is terminated via pull-up resistors and pull-down resistors. Only dominant data (logical 1) is transmitted; the recessive state (logical 0) is set via the termination. If no dominant state is transmitted, automatic reception is possible.

The received data—the signal transmitter data signal—is received via data inputs 9, 13, both via the first interface 6 and the second interface 7. The second interface 7 receives the signal transmitter data signal synchronously with the clock signal 50 (one data bit per clock cycle). This enables convenient processing of the user data in the microcontroller's firmware. The first interface 6 receives the signal transmitter data signal with the integer higher internal SPI clock—in accordance with the interface clock signal. This enables subsequent data analysis, as is required, for example, for evaluating the recovery time.

For the purpose of evaluating the recovery time (which is particularly important for safety), the first interface 6 can be clocked internally—i.e., the clock of the interface clock signal is continued while the clock of clock signal 50 is terminated and only a sequence of high levels is output to the signal transmitter 3 via the first data output 8. In this way, the recovery time can be sampled with the clock frequency via the first interface 6.

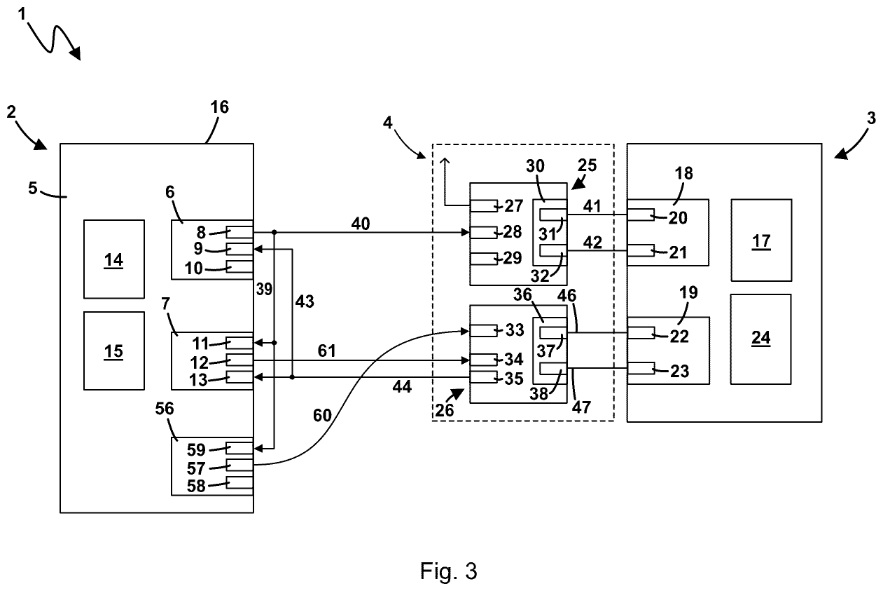

FIG. 3 shows a system 1 according to a second embodiment. Except for the differences explained below, the second embodiment is expediently designed like the first embodiment, so that the above explanations also apply to the second embodiment in this respect.

The computing unit 5 of the second embodiment expediently comprises a third serial interface 56. It should be noted that the computing unit 5 of the first embodiment is not limited to having only two serial interfaces, but may (also) have one or more additional serial interfaces.

The third serial interface 56 is designed in particular as a third SPI interface. The third serial interface 56 has a third data output 57, a third data input 58, and a clock input 59. The third data output 57 is in particular an SPI-MISO connection. The third data input 58 is, in particular, an SPI-MOSI connection.

The third data output 57 is connected to the second switching input 33 via a switching line 60.

The second data output 12 is connected to the second signal converter input 34 via a readout device data signal line 61.

No pull-up resistor or pull-down resistor is connected to the data lines 46, 47, for example. The computing unit 5 is configured to selectively set the second signal converter port 36 to input mode or output mode via the third data output 57 and, in output mode, to output the readout device data signal and, in input mode, to receive the signal transmitter data signal via the first data input 9 and/or the second data input 13.

1. A readout device for industrial automation, for reading out a signal transmitter, wherein the readout device comprises: a computing unit comprising a first serial interface and a second serial interface, wherein the first serial interface has a first data output and a first data input, and the second serial interface has a second data output, a second data input and a clock input, wherein the clock input is connected to the first data output and the computing unit is configured to output a clock signal at the first data output for clocking both the signal transmitter to be read out and the second serial interface, and to receive, by means of the first data input and/or the second data input, a signal transmitter data signal originating from the signal transmitter.

2. The readout device according to claim 1, wherein the computing unit is a microcontroller.

3. The readout device according to claim 1, wherein the first serial interface is a first SPI interface and/or the second serial interface is a second SPI interface.

4. The readout device according to claim 1, wherein the computing unit is configured to output a readout device data signal to the signal transmitter via the second data output.

5. The readout device according to claim 1, wherein the readout device is configured to operate the first serial interface at a higher clock frequency than the second serial interface for reading out the signal transmitter.

6. The readout device according to claim 1, wherein the computing unit is configured to receive the signal transmitter data signal via the first data input in order to detect, on the basis of the signal transmitter data signal, a time value related to the operation of the signal transmitter.

7. The readout device according to claim 6, wherein the time value is a time difference between an end of a clock provided with the clock signal and a level change of the signal transmitter data signal caused thereby.

8. The readout device according to claim 7, wherein the readout device is configured to provide, based on the time value, diagnosis information regarding the signal transmitter.

9. A system comprising a readout device according to claim 1 and a signal transmitter.

10. The system according to claim 9, wherein the signal transmitter comprises a position encoder that is configured to provide the signal transmitter data signal.

11. The system according to claim 9, further comprising a signal converter device connected between the readout device and the signal transmitter so that the clock signal, the signal transmitter data signal and/or the readout device data signal passes through the signal converter device, wherein the signal converter device is configured to perform, for the clock signal, the signal transmitter data signal and/or the readout device data signal, level conversion and/or signal transmission mode conversion between single-ended signal transmission and differential signal transmission.

12. The system according to claim 11, wherein the signal converter device comprises at least one RS485 interface by means of which the level conversion and/or the signal transmission conversion is performed.

13. The system according to claim 11, wherein the signal converter device comprises at least a switching input, a signal converter input, a signal converter output, and a bidirectional signal converter port, wherein the bidirectional signal converter port is connected to a bidirectional signal transmitter data port of the signal transmitter and can be switched via the switching input between an input mode for receiving the signal transmitter data signal from the signal transmitter data port and an output mode for outputting the readout device data signal to the signal transmitter data port, and wherein the signal converter input is set to a fixed voltage level, the switching input is connected to the second data output of the readout device, and the signal converter output is connected to the second data input and/or the first data input of the readout device.

14. The system according to claim 13, wherein the signal converter port is connected to the signal transmitter data port via a first data line for non-inverted signal transmission and a second data line for inverted signal transmission, and wherein the system further comprises a pull-up resistor connected to the second data line and a pull-down resistor connected to the first data line.

15. The system according to claim 11, wherein the signal converter device comprises at least a switching input, a signal converter input, a signal converter output, and a bidirectional signal converter port, wherein the bidirectional signal converter port is connected to a bidirectional signal transmitter data port of the signal transmitter and can be switched via the switching input between an input mode for receiving the signal transmitter data signal from the signal transmitter data port and an output mode for outputting the readout device data signal to the signal transmitter data port, and wherein the computing unit has a third serial interface with a third data output to which the switching input is connected, the signal converter input is connected to the second data output, and the signal converter output is connected to the second data input and/or the first data input.

16. A method for operating a readout device according to claim 1, comprising the steps: outputting the clock signal for clocking both the signal transmitter to be read out and the second serial interface, and receiving, by means of the first data input and/or the second data input, the signal transmitter data signal originating from the signal transmitter.

17. The readout device according to claim 1, wherein the first serial interface has a clock output.
